(19) United States
(12) Patent Application Publication
(10) Pub. No.: US 2021/0002501 A1
(43) Pub. Date: Jan. 7, 2021

(54) AQUEOUS INKJET INK, PRINTED MATTER, AND INKJET RECORDING METHOD

(71) Applicant: Konica Minolta, Inc., Tokyo (JP)

(72) Inventors: Takayuki TOEDA, Suginami-ku, Tokyo (JP); Haruka MORIYAMA, Musashino-shi, Tokyo (JP); Hirotaka TAGORI, Kawasaki-shi, Kanagawa (JP)

(21) Appl. No.: 16/975,262

(22) PCT Filed: Mar. 23, 2018
(86) PCT No.: PCT/JP2018/011630

§ 371 Date: Aug. 24, 2020

(51) Int. Cl. C09D 11/322; B41M 5/00

(52) U.S. Cl. CPC C09D 11/322; B41M 5/0023

(57) ABSTRACT

Provided is an aqueous inkjet ink containing water, a pigment, an organic solvent, a resin, and a surfactant, wherein an alcohol is contained as the organic solvent; the resin is a water-insoluble resin containing at least one of a polyester skeleton, a polyolefin skeleton, and a polyurethane skeleton; and a silicone surfactant having a structure represented by Formula (1) is contained as the surfactant,

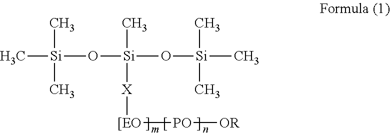

wherein, R represents a hydrogen atom or a hydrocarbon group having 1 to 4 carbon atoms; X is an alkylene group having 2 to 6 carbon atoms; EO represents an opened structure of an ethylene oxide group, PO represents an opened structure of a propylene oxide group, and an order of [EO]m and [PO]n is arbitrary; m and n represent a number of EO and PO, m is an integer of 2 to 50, and n is an integer of 0 to 20.

### TECHNICAL FIELD

The present invention relates to an aqueous inkjet ink, a printed matter, and an inkjet recording method. More particularly, the present invention relates to an aqueous inkjet ink which is excellent in wettability with respect to a substrate, and is excellent in ink storage stability and water resistance.

### BACKGROUND

Since the inkjet method can produce an image easily and inexpensively, it has been applied to various printing fields including photography, various types of printing, marking, and special printing such as color filters. In particular, the inkjet method is particularly suitable for uses in which a variety of images are formed in small quantities, since digital printing is possible without using a printing plate.

Inkjet inks used in the inkjet method include a plurality of types such as an aqueous ink composed of water and a small amount of an organic solvent, a non-aqueous ink containing an organic solvent but not substantially containing water, a hot-melt ink that is heated to melt a solid ink at room temperature for printing, and an active ray curable ink that is cured by irradiation with active ray after printing. Among these, an aqueous ink is widely used in household printers because of their low odor and high safety.

In order to print such an aqueous inkjet ink on a hardly absorbent substrate such as vinyl chloride, it is known that the wettability of ink is improved by using a silicone surfactant or an organic solvent to provide printability (refer to, for example, Patent Documents 1 and 2). In particular, the silicone surfactant is preferably used to reduce the surface tension of the ink, but its wettability was not sufficient for a non-absorbent substrate typified by polypropylene. In addition, due to the stability of silicone surfactants, it is not possible to add a large amount of one surfactant. It is disclosed that a specific silicone surfactant is used in combination to achieve both the wettability to the substrate and the storage stability of the ink (refer to Patent Document 3). However, the desired wettability and stability cannot be satisfied. Further, it is required to improve the water resistance of the coating film itself.

### PRIOR ART DOCUMENTS

### Patent Documents

Patent Document 1: Japanese Patent No. 5928028

Patent Document 2: Japanese Patent No. 5817027

Patent Document 3: Japanese Patent No. 5928027

### SUMMARY OF THE INVENTION

### Problems to be Solved by the Invention

The present invention has been made in view of the above-mentioned problems and situation, and an object of the present invention is to provide an aqueous inkjet ink which is excellent in wettability with respect to a substrate, and is excellent in ink storage stability and water resistance. An object of the present invention is also to provide a printed matter, and an inkjet recording method.

### Means to Solve the Problems

In order to solve the above-mentioned problems, the present inventors has examined the cause of the above-mentioned problems. The inventors have found that the inclusion of a specific silicone surfactant and a specific organic solvent improves the wettability with respect to the substrate, the storage stability of the ink, and the water resistance. Thus, the present invention has been achieved. That is, the above-mentioned problem according to the present invention is solved by the following means.

1. An aqueous inkjet ink comprising at least water, a pigment, an organic solvent, a resin, and a surfactant, wherein an alcohol is contained as the organic solvent; the resin is a water-insoluble resin containing at least one of a polyester skeleton, a polyolefin skeleton, and a polyurethane skeleton; and a silicone surfactant having a structure represented by the following Formula (1) is contained as the surfactant.

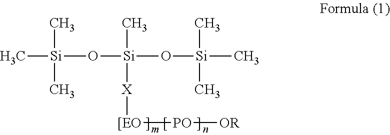

In Formula (1), R represents a hydrogen atom or a hydrocarbon group having 1 to 4 carbon atoms. X is an alkylene group having 2 to 6 carbon atoms and may have a branched structure. EO represents a repeating unit structure of an ethylene oxide group, PO represents a repeating unit structure of a propylene oxide group, and an order of [EO]ₘ and [PO]ₙ is arbitrary. m and n represent a number of the repeating unit structures, m is an integer of 2 to 50, and n is an integer of 0 to 20.

2. The aqueous inkjet ink described in the item 1, wherein a content of the silicone surfactant is in the range of 0.1 to 3.0 mass % with respect to a total mass of the ink.
3. The aqueous inkjet ink described in the item 1 or 2, wherein the alcohol having 1 to 3 hydroxy groups is contained as the organic solvent.
4. The aqueous inkjet ink described in any one of the items 1 to 3, wherein the organic solvent is at least one selected from the group consisting of 1,2-ethanediol, 3-oxapentane-1,5-diol, 1,2-propanediol, 1,3-propanediol, 2-methyl-1,3-propanediol, 2,2-dimethyl-1,3-propanediol, 1,4-butanediol, 2-methyl-2,4-pentanediol, 3-methyl-1,5-pentanediol, and 1,6-hexanediol.
5. The aqueous inkjet ink described in any one of the items 1 to 4, wherein a content of the organic solvent is in the range of 10 to 50 mass % with respect to a total mass of the ink.
6. A printed matter having a printing layer on a non-absorbent film substrate formed with the aqueous inkjet ink described in any one of the items 1 to 5.
7. An inkjet recording method comprising the step of recording an image on a non-absorbent film substrate by using the aqueous inkjet ink described in any one of the items 1 to 5.

### Effects of the Invention

According to the above-mentioned means of the present invention, it is possible to provide an aqueous inkjet ink, a printed matter, and an inkjet recording method, which are excellent in wettability to a substrate, storage stability, and water resistance. The expression mechanism or the action mechanism of the effects of the present invention has not been clarified, but is presumed as follows.

### (Effect of Silicone Surfactant)

A silicone surfactant is a surfactant having a polysiloxane skeleton, and its characteristics are derived from the structure of polysiloxane. It is generally known that the length of the main chain formed of a siloxane unit (—Si—O—) controls the ability to reduce the surface tension. That is, as the siloxane main chain becomes shorter, the compatibility in the ink is improved and the surface tension will be lowered. The silicone surfactant provided with the polysiloxane structure having the structure represented by Formula (1) in the present invention has the shortest chain unit for satisfying both of these. It is possible to effectively impart the wettability of the ink to the low-absorbent substrate or the non-absorbent substrate. In addition, when controlling the compatibility of the silicone surfactant according to the application, it is possible to organically modify the siloxane unit (—Si—O—) at the site corresponding to the side chain or terminal. When used in an aqueous ink, it is necessary to make the silicone surfactant itself highly polar, and in general, polyether modification using polyethylene oxide or polypropylene oxide is used. Since the silicone portion is hydrophobic, the polyether portion is oriented in water or the organic solvent to be contained, and the compatibility is improved. Therefore, both storage stability and wettability will be imparted.

### (Effect of Organic Solvent)

Further, it was found that coexistence of alcohols such as diol solvents (including glycol solvents) and mono-alcohol solvents, which are specific organic solvents, further improves storage stability in addition to the above storage stability and wettability imparted. It is considered that this is because the structure having a hydroxy group and having an appropriate molecular weight will stabilize the ink by suppressing aggregation between the pigment dispersion and the resin articles.

### (Effect of Water-Insoluble Resin)

Further, water-insoluble resins such as polyester resins, polyolefin resins and polyurethane resins are known to have excellent adhesion to non-absorbent substrates such as polypropylene (PP) and polyethylene terephthalate (PET). However, a water-insoluble resin contained in a hydrophilic medium such as an aqueous ink is difficult to spread evenly on a coating film, especially with respect to a polypropylene substrate, and coating unevenness occurs, resulting in poor adhesion. Therefore, by combining with the silicone surfactant having the structure represented by Formula (1) in the present invention, the water-insoluble resin may be suitably wet and spread, and it becomes possible to secure the adhesion to the non-absorbent substrate.

### (Water Resistance)

More surprisingly, by using the specific silicone surfactant having the structure represented by Formula (1) in the present invention and the specific water-insoluble resin in combination, it was found that the water resistance of the ink film when formed into a coating is improved. This is because the silicone surfactant ensures the wettability to the substrate, and the organic solvent having a hydroxy group enters between the pigment dispersion particles and the resin particles in the ink drying process, thereby it is presumed that hydrogen bonds are generated between the particles, and the particles are dried while the particles are regularly oriented due to the hydrogen bonds. This results in forming a state in which the particles are evenly arranged in the final coating film, and the water resistance is improved.

### BRIEF DESCRIPTION OF THE DRAWINGS

FIG. 1 is a schematic diagram illustrating an example of an inkjet recording apparatus preferably used for the present invention.

### EMBODIMENTS TO CARRY OUT THE INVENTION

The aqueous inkjet ink of the present invention is an aqueous inkjet ink containing at least water, a pigment, an organic solvent, a resin, and a surfactant, wherein an alcohol is contained as the organic solvent; the resin is a water-insoluble resin containing at least one of a polyester skeleton, a polyolefin skeleton, and a polyurethane skeleton; and a silicone surfactant having a structure represented by the following Formula (1) is contained as the surfactant. This feature is a technical feature common to or corresponding to each of the following embodiments.

As an embodiment of the present invention, when the content of the silicone surfactant is in the range of 0.1 to 3 mass % with respect to the total amount of the ink, it is preferable in that the storage stability of the ink is excellent and effective ink wettability may be imparted.

Further, it is preferable that the organic solvent contains an alcohol having 1 to 3 hydroxy groups from the viewpoint of improving storage stability. That is, the hydroxy group of the organic solvent and the structure having an appropriate molecular weight suppress the aggregation between the pigment dispersion and the resin fine particles and improve the storage stability.

In particular, it is preferable to contain at least one of the following compounds as the organic solvent in terms of superior storage stability: 1,2-ethanediol (ethylene glycol), 3-oxapentane-1,5-diol (diethylene glycol), 1,2-propanediol (propylene glycol), 1,3-propanediol, 2-methyl-1,3-propanediol, 2,2-dimethyl-1,3-propanediol, 1,4-butanediol, 2-methyl-2,4-pentanediol, 3-methyl-1,5-pentanediol, and 1,6-hexanediol.

It is preferable that the content of the organic solvent is in the range of 10 to 50 mass % with respect to a total mass of the ink in terms of storage stability.

The printed matter of the present invention is characterized by having a printing layer formed by using the aqueous inkjet ink on a non-absorbent film substrate. According to the printed matter, it is possible to obtain a printed matter with high image quality that is excellent in adhesion to the substrate, storage stability, and water resistance.

The inkjet recording method of the present invention is characterized by recording an image on a non-absorbent film substrate using the above-mentioned aqueous inkjet ink. According to the inkjet recording method, it is possible to obtain a high-quality printed matter that has excellent adhesion to a substrate, storage stability, and water resistance.

Hereinafter, the present invention, the constitution elements thereof, as well as configurations and embodiments to carry out the present invention will be described. In the present description, when two figures are used to indicate a range of value before and after “to”, these figures are included in the range as a lowest limit value and an upper limit value.

### (1) Aqueous Inkjet Ink

The aqueous inkjet ink of the present invention (it may be called as an “inkjet ink” or an “ink”) is an aqueous inkjet ink containing at least water, a pigment, an organic solvent, a resin, and a surfactant, wherein an alcohol is contained as the organic solvent; the resin is a water-insoluble resin containing at least one of a polyester skeleton, a polyolefin skeleton, and a polyurethane skeleton; and a silicone surfactant having a structure represented by the following Formula (1) is contained as the surfactant.

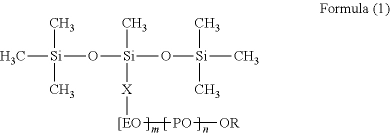

In Formula (1), R represents a hydrogen atom or a hydrocarbon group having 1 to 4 carbon atoms. X is an alkylene group having 2 to 6 carbon atoms and may have a branched structure. EO represents a repeating unit structure of an ethylene oxide group, PO represents a repeating unit structure of a propylene oxide group, and an order of [EO]ₘ and [PO]ₙ is arbitrary. m and n represent a number of the repeating unit structures, m is an integer of 2 to 50, and n is an integer of 0 to 20.

In the present application, “EO” represents a repeating unit structure of polyethylene oxide, that is, a structure in which ethylene oxide, which is a three-membered cyclic ether, is opened. Further, “PO” represents a repeating unit structure of polypropylene oxide, that is, a structure in which propylene oxide which is a three-membered cyclic ether is opened. Here, “an order of [EO]ₘ and [PO]ₙ is arbitrary” means that, in the compound represented by Formula (1), the order of the bonding position with respect to the siloxane skeleton which is the base may be appropriately changed.

### (1.1) Silicone Surfactant

In Formula (1), R is preferably a hydrogen atom, a methyl group, an ethyl group, a propyl group or a butyl group, and more preferably a hydrogen atom or a methyl group. In Formula (1), X is preferably an alkylene group having 3 carbon atoms (that is, a propylene group), m is preferably an integer of 5 to 20 and n is preferably an integer of 0 to 6.

Specific examples of the silicone surfactant having the structure represented by Formula (1) include S-1 to S-8 below, but the present invention is not limited thereto.

(S-1): In Formula (1), R=a methyl group, X=an alkylene group having 3 carbon atoms, m=9, n=0
(S-2): In Formula (1), R=a butyl group, X=an alkylene group having 3 carbon atoms, m=25, n=6
(S-3): In Formula (1), R=a hydrogen atom, X=an alkylene group having 3 carbon atoms, m=3, n=0
(S-4): In Formula (1), R=a hydrogen atom, X=an alkylene group having 3 carbon atoms, m=33, n=0
(S-5): In Formula (1), R=a hydrogen atom, X=an alkylene group having 3 carbon atoms, m=22, n=16
(S-6): In Formula (1), R=a hydrogen atom, X=an alkylene group having 3 carbon atoms, m=9, n=0.
(S-7): In Formula (1), R=a hydrogen atom, X=an alkylene group having 3 carbon atoms, m=12, n=3
(S-8): In Formula (1), R=a hydrogen atom, X=an alkylene group having 3 carbon atoms, m=1, n=0.

It is preferable that the content of the silicone surfactant having the structure represented by Formula (1) is in the range of 0.1 to 3.0 mass % with respect to a total mass of the ink from the viewpoint that the storage stability is excellent, and ink wettability is effectively imparted.

The silicone surfactant according to the present invention may be synthesized, for example, according to the synthetic examples described below.

### (1.2) Organic Solvent

The organic solvent according to the present invention preferably contains an alcohol. More preferably, it contains an alcohol having 1 to 3 hydroxy groups.

Preferable examples of the mono-alcohol having one hydroxy group include methanol, ethanol, propanol, isopropanol, butanol, isobutanol, secondary butanol, and tertiary butanol. Examples of the diol having two hydroxy groups include 1,2-ethanediol (ethylene glycol), 3-oxapentane-1,5-diol (diethylene glycol), 1,2-propanediol (propylene glycol), 1,3-propanediol, 2-methyl-1,3-propanediol, 2,2-dimethyl-1,3-propanediol, 1,4-butanediol, 2-methyl-2,4-pentanediol, 3-methyl-1,5-pentanediol, and 1,6-hexanediol. Examples of the triol having three hydroxy groups include 1,2,3-propanetriol, trimethylolpropane, and trimethylolethane.

In particular, it is preferable to contain at least one of the following compounds as the organic solvent in terms of superior storage stability: 1,2-ethanediol (ethylene glycol), 3-oxapentane-1,5-diol (diethylene glycol), 1,2-propanediol (propylene glycol), 1,3-propanediol, 2-methyl-1,3-propanediol, 2,2-dimethyl-1,3-propanediol, 1,4-butanediol, 2-methyl-2,4-pentanediol, 3-methyl-1,5-pentanediol, and 1,6-hexanediol.

As the organic solvent according to the present invention, other organic solvents other than the alcohols having 1 to 3 hydroxy groups may be further used. As the other organic solvent, a water-soluble organic solvent is preferable, and for example, amines, amides, and glycol ethers may be preferably exemplified.

Preferable examples of the amine include ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine.

Preferable examples of the amide include formamide, N,N-dimethylformamide, and N, N-dimethylacetamide.

Preferable examples of the glycol ether include ethylene glycol monoethyl ether, ethylene glycol monobutyl ether, diethylene glycol monoethyl ether, diethylene glycol monobutyl ether, triethylene glycol monobutyl ether, propylene glycol monopropyl ether, dipropylene glycol monomethyl ether, and tripropylene glycol monomethyl ether.

When the inkjet ink contains two or more kinds of organic solvents, the mass ratio of the glycols and diols with respect to the mass of the entire organic solvents is preferably 50% or more.

Further, the content of the organic solvent according to the present invention is preferably in the range of 10 to 50 mass % with respect to the inkjet ink from the viewpoint of excellent storage stability.

### (1.3) Resin

The resin according to the present invention is a water-insoluble resin containing at least one of a polyester skeleton, a polyolefin skeleton and a polyurethane skeleton. In the present invention, the water-insoluble resin is a resin that is insoluble in water in a weakly acidic or weakly basic range, and preferably has a solubility of 0.5% or less in an aqueous solution having a pH of 4 to 10 (25° C.).

The water-insoluble resin according to the present invention is preferably a water-insoluble resin containing a polyurethane skeleton. The number average molecular weight of the water-insoluble resin may be in the range of 3,000 to 500,000, preferably in the range of 7,000 to 200,000.

### (1.3.1) Polyester Resin

The polyester resin having a polyester skeleton contained in the water-insoluble resin is obtained by using a polyhydric alcohol component and a polycarboxylic acid component such as polycarboxylic acid, polycarboxylic acid anhydride, and polycarboxylic acid ester. Examples of the polyhydric alcohol component are: divalent alcohols (diols) such as alkylene glycols having 2 to 36 carbon atoms (ethylene glycol, 1,2-propylene glycol, 1,3-propylene glycol, 1,4-butylene glycol, and 1,6-hexanediol), alkylene ether glycols having 4 to 36 carbon atoms (diethylene glycol, triethylene glycol, dipropylene glycol, polyethylene glycol, polypropylene glycol, and polybutylene glycol), alicyclic diols having 6 to 36 carbon atoms (1,4-cyclohexanedimethanol and hydrogenated bisphenol A), adducts of the alicyclic diols with alkylene oxide having 2 to 4 carbon atoms (ethylene oxide (abbreviated as EO), propylene oxide (PO), and butylene oxide (BO)) (adduct mole number: 1 to 30), adducts of bisphenols (bisphenol A, bisphenol F, and bisphenol S) with alkylene oxide having 2 to 4 carbon atoms (EO, PO, and BO) (adduct mole number: 2 to 30). These may be used alone or in combination of two or more.

Examples of the polycarboxylic acid component are: divalent carboxylic acid (dicarboxylic acid) such as alkanedicarboxylic acids having 4 to 36 carbon atoms (succinic acid, adipic acid, and sebacic acid), alkenyl succinic acids (e.g., dodecenyl succinic acid), alicyclic dicarboxylic acids having 4 to 36 carbon atoms (dimer acid (e.g., dimerized linoleic acid), alkene dicarboxylic acids having 4 to 36 carbon atoms (maleic acid, fumaric acid, citraconic acid, and mesaconic acid), and aromatic dicarboxylic acids having 8 to 36 carbon atoms (phthalic acid, isophthalic acid, terephthalic acid or derivatives thereof, and naphthalene dicarboxylic acid). These may be used alone or in combination of two or more.

The number average molecular weight of the polyester resin is preferably in the range of 1,000 to 50,000, and more preferably in the range of 2,000 to 20,000.

A commercially available product may be used as the polyester resin. Examples of the commercial product are: Elitel KA-5034 (product of Unitika Ltd., number average molecular weight: 8500), Elitel KA-5071 S (product of Unitika Ltd., number average molecular weight: 8500), Elitel KA-1449 (product of Unitika Ltd., number average molecular weight: 7000), Elitel KA-0134 (product of Unitika Ltd., number average molecular weight: 8500), Elitel KA-3556 (product of Unitika Ltd., number average molecular weight: 8000), Elitel KA-6137 (product of Unitika Ltd., number average molecular weight: 5000), Elitel KZA-6034 (product of Unitika Ltd., number average molecular weight: 6500), Elitel KT-8803 (product of Unitika Ltd., number average molecular weight: 15000), Elitel KT-8701 (product of Unitika Ltd., number average molecular weight: 13000), Elitel KT-9204 (product of Unitika Ltd., number average molecular weight: 17,000, Elitel KT-8904 (product of Unitika Ltd., number average molecular weight: 17000), Elitel KT-0507 product of Unitika Ltd., number average molecular weight: 17000), Elitel KT-9511 (product of Unitika Ltd., number average molecular weight: 17000). These may be used alone or in combination of two or more.

### (1.3.2) Polyolefin Resin

Examples of the polyolefin resin having a polyolefin skeleton which is contained in the water-insoluble resin may be modified polyolefins such as polyolefins modified with unsaturated carboxylic acids and/or acid anhydrides.

Examples of the polyolefin include: polyethylene, polypropylene, ethylene-propylene copolymer, random copolymers or block copolymers of ethylene and/or propylene with other comonomers (α-olefin comonomers having 2 or more carbon atoms, preferably 2 to 6 carbon atoms such as 1-butene, 1-pentene, 1-hexene, 1-heptene, 1-octene, and 1-nonene) (e.g., ethylene-propylene-butene copolymers etc.). Moreover, the substances obtained by co-polymerization of two or more types of these other comonomers may be used. In addition, two or more of these polymers may be used by mixing.

As the modified polyolefin, a polyolefin modified with an unsaturated carboxylic acid and/or an acid anhydride and/or a compound having one or more double bonds per molecule is preferably used.

Examples of an unsaturated carboxylic acid and an acid anhydride include α,β-unsaturated carboxylic acids and their anhydrides. Specific examples thereof are: maleic acid, maleic anhydride, fumaric acid, citraconic acid, citraconic anhydride, mesaconic acid, itaconic acid, itaconic anhydride, aconitic acid, and aconitic anhydride. These may be used alone or in combination of two or more. When two or more are used in combination, the physical properties of the coating often become good.

As the compound having one or more double bonds per one molecule, a (meth)acrylic acid monomer may be cited. Examples of the (meth)acrylic acid monomer are: methyl (meth)acrylate, ethyl (meth)acrylate, propyl (meth)acrylate, butyl (meth)acrylate, 2-hydroxyethyl (meth)acrylate, 2-hydroxypropyl (meth)acrylate, 4-hydroxybutyl (meth)acrylate, cyclohexyl (meth)acrylate, tetrahydrofurfuryl (meth)acrylate, isobornyl (meth)acrylate, benzyl (meth)acrylate, 2-hydroxybutyl (meth)acrylate, benzyl (meth)acrylate, glycidyl (meth)acrylate, (meth)acrylic acid, (di)ethylene glycol di(meth)acrylate, di (meth) acrylic acid 1,4-butanediol di(meth)acrylate, 1,6-hexanediol di(meth)acrylate, trimethylolpropane tri(meth)acrylate, glycerol di(meth)acrylate, 2-ethylhexyl (meth)acrylate, lauryl (meth)acrylate, stearyl (meth)acrylate, and stearyl acrylamide. A styrene monomer may be also cited. Examples of the styrene monomer are: styrene, α-methylstyrene, paramethylstyrene, and chloromethylstyrene. Other usable monomers include vinyl monomers such as divinyl benzene, vinyl acetate, and vinyl esters of versatic acid. Here, (meth) acrylic acid indicates acrylic acid and methacrylic acid.

Modification of the polyolefin is carried out by dissolving the polyolefin once in an organic solvent such as toluene or xylene, and in the presence of a radical generator, by reacting α,β-unsaturated carboxylic acid and/or its acid anhydride and/or a compound having one or more double bonds per molecule. Alternatively, in an autoclave which may be reacted in a molten state capable of raising the temperature to the softening temperature or melting point of the polyolefin or higher, or in a uniaxial or biaxial multiaxial extruder, in the presence or absence of a radical generator, modification may be carried out by reacting α,β-unsaturated carboxylic acid and/or its acid anhydride and/or a compound having one or more double bonds per molecule.

Examples of the radical generator are: peroxides such as di-tert-butyl perphthalate, tert-butyl hydroperoxide, dicumyl peroxide, benzoyl peroxide, tert-butyl peroxybenzoate, tert-butyl peroxyethyl hexanoate, tert-butyl peroxypivalate, methyl ethyl ketone peroxide, and di-tert-butyl peroxide; and azonitrile compounds such as azobisisobutyronitrile and azobisisopropionitrile. When graft copolymerization is carried out using these peroxides, the amount of peroxide is preferably in the range of 0.1 to 50 parts by mass, particularly preferably in the range of 0.5 to 30 parts by mass with respect to the mass of the polyolefin.

The above-mentioned polyolefin resin may be manufactured by a publicly known method, and there is no limitation in particular about each manufacturing method or modification degree.

The polyolefin resin used in the present invention preferably has a weight average molecular weight in the range of 20,000 to 100,000. When it is 20,000 or more, the cohesion of the coating film becomes strong, and the coating film physical properties such as adhesion and solvent resistance (gasohol resistance) are improved. When it is 100,000 or less, the solubility with respect to the organic solvent is good, and particle size reduction of the emulsified dispersion is promoted. The weight average molecular weight is a value measured by gel permeation chromatography (GPC). For example, by using “RID-6A” manufactured by Shimadzu Corporation (column: Tosoh Corporation “TSK-GEL”, solvent: tetrahydrofuran (THF) and column temperature: 40° C.), it may be determined from a calibration curve prepared with polystyrene standard samples.

In the present invention, commercially available polyolefin resins may also be used. As resin particles made of resin having polyolefin structure, the following may be used: “AUROREN 150A” (polyolefin resin fine particles), “SUPERCHLON E-415” (polypropylene resin fine particles), and “AUROREN AE-301” (polyolefin resin fine particles) (made by Nippon Paper Industries Co., Ltd.); and “HARDLEN Na-1001” (made by Toyo Kasei Co., Ltd.).

### (1.3.3) Polyurethane Resin

As a polyurethane resin having a polyurethane skeleton contained in the water-insoluble resin, a substance having a hydrophilic group is used. As such a hydrophilic group, a carboxy group (—COOH) and a salt thereof, and a sulfonic acid group (—SO₃H) and a salt thereof may be mentioned. Examples of the salt include alkali metal salts such as sodium salt and potassium salt, and amine salts. Among these, as a hydrophilic group, a carboxy group or a salt thereof is preferable.

The polyurethane resin contained in the water-insoluble resin according to the present invention is preferably an aqueous dispersion of a self-emulsifying polyurethane having a water-soluble functional group in the molecule, or an aqueous dispersion of forced emulsification type polyurethane prepared by emulsifying with a strong mechanical shear force using a surfactant. The polyurethane resin in the above-mentioned aqueous dispersion is obtained by the reaction of a polyol with an organic polyisocyanate and a hydrophilic group containing compound.

Examples of a polyol which may be used for preparation of polyurethane resin aqueous dispersion are: polyester polyol, polyether polyol, polycarbonate polyol, and polyolefin type polyol. Among them, it is preferable to use a polyether polyol or a polycarbonate polyol to form a structure having a carbonate group or an ether group in a urethane resin.

Polyester polyols include condensation products made of low molecular weight polyols and polycarboxylic acids. Examples of the low molecular weight polyol are: ethylene glycol, diethylene glycol, triethylene glycol, 1,2-propylene glycol, 1,3-propylene glycol, neopentyl glycol, 1,3-butanediol, 1,4-butanediol, 3-methylpentanediol, hexamethylene glycol, 1,8-octanediol, 2-methyl-1,3-propanediol, bisphenol A, hydrogenated bisphenol A, trimethylolpropane, and cyclohexane dimethanol. Examples of the polycarboxylic acid are: succinic acid, glutaric acid, adipic acid, sebacic acid, phthalic acid, isophthalic acid, terephthalic acid, trimellitic acid, tetrahydrofuranic acid, endomethine tetrahydrofuranic acid, and hexahydrophthalic acid.

As polyether polyols, various polyether polyols may be mentioned. Examples of the polyether polyol are: polyethylene glycol, polypropylene glycol, polyethylene polytetramethylene glycol, polypropylene polytetremethylene glycol, and polytetramethylene glycol.

The polycarbonate polyol may be obtained, for example, by the reaction of a carbonic acid derivative such as diphenyl carbonate, dimethyl carbonate or phosgene with a diol. Examples of the diol are: ethylene glycol, diethylene glycol, triethylene glycol, 1,2-propylene glycol, 1,3-propylene glycol, neopentyl glycol, 1,3-butanediol, 1,4-butanediol, 3-methylpentanediol, hexamethylene glycol, 1,8-octanediol, 2-methyl-1,3-propanediol, bisphenol A, hydrogenated bisphenol A, trimethylolpropane, and cyclohexane dimethanol. Among these, polycarbonate polyols using 1,6-hexanediol are preferable from the viewpoint of weather resistance and solvent resistance.

As the organic polyisocyanate, those known in the field of urethane industry may be used. Examples thereof are: aromatic isocyanates such as tolylene diisocyanate (TDI), diphenylmethane diisocyanate (MDI), polymeric (MDI), xylylene diisocyanate (XDI), and tetramethyl xylylene diisocyanate (TMXDI); aliphatic isocyanate such as hexamethylene diisocyanate (HMDI); alicyclic isocyanates such as isophorone diisocyanate (IPDI), and 4,4′-dicyclohexylmethane diisocyanate (hydrogenated MDI, H12MDI). These may be used alone, or may be used in combination of two or more. Among these, it is preferable to use aliphatic isocyanate and/or alicyclic isocyanate. When non-yellowing is required, it is preferable to use HMDI for aliphatic isocyanates, IPDI and H12MDI for alicyclic isocyanates, and XDI and TMXDI for aromatic isocyanates.

As a hydrophilic group containing compound, a compound which has one or more active hydrogen atoms and the above-mentioned hydrophilic group in a molecule is mentioned. Examples thereof are: compounds containing a carboxylic group such as 2,2-dimethylol propionic acid, 2,2-dimethylol butanoic acid, 2,2-dimethylol butyric acid, 2,2-dimethylol valeric acid, and glycine, and their derivatives of sodium salts, potassium salts, and amine salts; compounds containing a sulfonic acid group such as taurine (i. e., aminoethyl sulfonic acid), and ethoxypolyethylene glycol sulfonic acid, and their derivatives of sodium salts, potassium salts, and amine salts.

The polyurethane resin according to the present invention may be produced as follows. Firstly, a urethane prepolymer is obtained by mixing a polyol, an organic polyisocyanate and a hydrophilic group containing compound and reacting them at 30 to 130° C. for 30 minutes to 50 hours by a known method.

The obtained urethane prepolymer is extended and polymerized by a chain extender to obtain a polyurethane resin having a hydrophilic group. As a chain extender, water and/or an amine compound is preferably used. By using water or an amine as a chain extender, the isocyanate-terminated prepolymer may be efficiently elongated by reacting with a free isocyanate in a short time.

The amine compound as a chain extender include polyamines. Examples of the polyamine are: aliphatic polyamines such as ethylenediamine and triethylenediamine; aromatic polyamines such as meta xylene diamine and toluylene diamine; hydrazine; and polyhydrazino compound such as adipic acid dihydrazide. The amine compounds may contain, together with the above-mentioned polyamine, a monovalent amine such as dibutylamine or methyl ethyl ketoxime as a reaction terminator to such an extent that polymerization is not significantly inhibited.

In the synthesis of the urethane prepolymer, a solvent which is inert to isocyanate and which can dissolve the urethane prepolymer may be used. Examples of the solvent include: dioxane, methyl ethyl ketone, dimethylformamide, tetrahydrofuran, N-methyl-2-pyrrolidone, toluene, and propylene glycol monomethyl ether acetate. It is preferable that these hydrophilic organic solvents used in the reaction step are finally removed.

In addition, in the synthesis of the urethane prepolymer, a catalyst may be added to accelerate the reaction. Examples thereof are: amine catalysts (e.g., triethylamine, N-ethylmorpholine, and triethyldiamine), tin-based catalysts (e.g., dibutyltin dilaurate and dioctyltin dilaurate), and titanium-based catalysts (e.g., tetrabutyl titanate).

The molecular weight of the polyurethane resin is preferably as large as possible by introducing a branched structure or an internal cross-linking structure. The molecular weight is preferably in the range of 50,000 to 10,000,000. When the molecular weight is increased to be insoluble in the solvent, a coating film having excellent weather resistance and water resistance may be obtained.

In the present invention, a commercially available polyurethane resin may also be used. For example, cationic or nonionic polyurethane resin particles may be preferably used.

Specific examples of the cationic or nonionic polyurethane resin particles are cited in the following. Examples of the cationic polyurethane resin particles are: “SUPERFLEX 620” and “SUPERFLEX 650” (“SUPERFLEX” is a registered trademark of Dai-ichi Kogyo Seiyaku Co., Ltd.) and “PERMARIN UC-20” (“PERMARIN” is a registered trademark of Sanyo Chemical Industries, Ltd.), and “PARASURF UP-22” made by Ohara Palladium Chemical Co., Ltd. Examples of the nonionic polyurethane resin particles are: “SUPERFLEX 500M” and “SUPERFLEX E-2000” made by Dai-ichi Kogyo Seiyaku Co., Ltd.

### (1.4) Pigment

As the pigment according to the present invention, it is possible to use an anionic dispersing pigment, for example, an anionic self-dispersing pigment, or a pigment dispersed with an anionic polymer dispersing agent. In particular, one in which the pigment is dispersed by an anionic polymer dispersant is preferable.

As the pigment, conventionally known pigments may be used without particular limitation, and, for example, organic pigments such as insoluble pigments and lake pigments, and inorganic pigments such as titanium oxide may be preferably used.

The insoluble pigment is not limited. Preferable examples of the insoluble pigment are: azo, azomethine, methine, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, and diketopyrrolopyrrole pigments.

Specific organic pigments that may be preferably used include the following pigments.

Examples of a magenta or red pigment are: C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48: 1, C.I. Pigment Red 53: 1, C.I. Pigment Red 57: 1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 202, C.I. Pigment Red 222, and C.I. Pigment Violet 19.

Examples of an orange or yellow pigment are: C.I. Pigment Orange 31, C.I. Pigment Orange 43, C.I. Pigment Yellow 12, C.I. Pigment Yellow 13, C.I. Pigment yellow 14, C.I. Pigment Yellow 15, C.I. Pigment Yellow 15: 3, C.I. Pigment Yellow 17, C.I. Pigment Yellow 74, C.I. Pigment Yellow 93, C.I. Pigment Yellow 128, C.I. Pigment Yellow 94, C.I. Pigment Yellow 138, and C.I. Pigment Yellow 155. In particular, in view of the balance of color tone and light resistance, C.I. Pigment Yellow 155 is preferred.

Examples of a green or cyan pigment are: C.I. Pigment Blue 15, C.I. Pigment Blue 15: 2, C.I. Pigment Blue 15:3, C.I. Pigment Blue 16, C.I. Pigment Blue 60, and C.I. Pigment Green 7.

Examples of a black pigment are: C.I. Pigment Black 1, C.I. Pigment Black 6, and C.I. Pigment Black 7.

### (1.5) Dispersant

The dispersant used for dispersing the pigment is not particularly limited, and it is preferably a polymer dispersant having an anionic group, and those having a molecular weight in the range of 5,000 to 200,000 may be suitably used.

Examples of the polymer dispersant are: styrene, styrene derivatives, vinyl naphthalene derivatives, acrylic acid, acrylic acid derivatives, maleic acid, maleic acid derivatives, itaconic acid, itaconic acid derivatives, fumaric acid, block copolymers having a structure derived from two or more monomers selected from fumaric acid derivatives, random copolymers and salts thereof, polyoxyalkylenes, and polyoxyalkylene alkyl ethers.

The polymer dispersant preferably has an acryloyl group, and it is preferably neutralized by adding a neutralizing base. The neutralizing base is not particularly limited, and it is preferably an organic base such as ammonia, monoethanolamine, diethanolamine, triethanolamine or morpholine. In particular, when the pigment is titanium oxide, the titanium oxide is preferably dispersed by a polymer dispersant having an acryloyl group.

The addition amount of the polymer dispersant is preferably in the range of 10 to 100 mass %, and more preferably in the range of 10 to 40 mass % with respect to the pigment.

It is particularly preferred that the pigment is in the form of a so-called capsule pigment, in which the pigment is coated with the above-mentioned polymer dispersant. Various known methods may be used to coat the pigment with the polymer dispersant. For example, a phase inversion emulsification method, an acid precipitation method, or a method of dispersing a pigment with a polymerizable surfactant is performed, then, supplying a monomer thereto, and coating while polymerizing may be preferably exemplified.

Particularly preferable method is a follows: a water-insoluble resin is dissolved in an organic solvent such as methyl ethyl ketone, and the acid group in the resin is partially or completely neutralized with a base; then, a pigment and ion-exchange water are added thereto and the mixture is dispersed; thereafter, the organic solvent is removed and water is added according to necessity.

The average particle diameter of the pigment in the inkjet ink in the dispersed state is preferably in the range of 50 to 200 nm. Thereby, the dispersion stability of the pigment may be improved, and the storage stability of the ink may be improved. The particle size of the pigment may be measured by a commercially available particle size measuring instrument using a dynamic light scattering method or an electrophoresis method. The measurement by the dynamic light scattering method is simple, and the particle diameter range may be measured accurately.

The pigment may be used after being dispersed with a dispersing machine together with a dispersant and other necessary additives depending on the desired purposes.

As a dispersing machine, a ball mill, a sand mill, a line mill, and a high pressure homogenizer, which are conventionally known, may be used. Among them, dispersing the pigment by a sand mill is preferable because the particle size distribution becomes sharp. The material of the beads used for sand mill dispersion is not particularly limited, and it is preferably zirconia or zircon from the viewpoint of preventing formation of bead fragments and contamination of ionic components. Furthermore, the bead diameter is preferably in the range of 0.3 to 3 mm.

The content of the pigment in the inkjet ink is not particularly limited, and a range of 7 to 18 mass % is preferable for titanium oxide, and a range of 0.5 to 7 mass % is preferable for an organic pigment.

### (1.6) Water

The water contained in the aqueous inkjet ink of the present invention is not particularly limited, and may be ion-exchanged water, distilled water, or pure water.

### (1.7) Other Components

In the inkjet ink used in the present invention, various additives known in the art may be used, according to the purpose of improving the ejection stability, print head and ink cartridge compatibility, storage stability, image storability, and other various performances, as necessary. Examples of the additives are polysaccharides, viscosity modifiers, resistivity modifiers, film-forming agents, UV absorbers, antioxidants, anti-fading agents, fungicides, and anti-rust agents. They are appropriately selected and used. Specific examples are: oil droplets made of such as liquid paraffin, dioctyl phthalate, tricresyl phosphate, and silicone oil; UV absorbers described in JP-A 57-74193, JP-A 57-87988, and JP-A 62-261476; antifading agents described in JP-A 57-74192, JP-A 57-87989, JP-A 60-72785, JP-A 61-146591, JP-A 1-95091 and JP-A 3-13376; fluorescent whitening agents described in JP-A 59-42993, JP-A 59-52689, JP-A 62-280069, JP-A 61-242871, and JP-A 4-219266.

### (1.8) Physical Properties

The viscosity of the inkjet ink of the present is preferably in the range of 1 to 40 mPa·s at 25° C., and more preferably it is in the range of 2 to 10 mPa·s.

### (2) Method for Producing Aqueous Inkjet Ink

The method for producing an aqueous inkjet ink according to the present invention preferably comprises a step of mixing at least water, a pigment, an organic solvent, a resin and a surfactant.

### (2.1) Mixing Step

In this step, at least water, the pigment, the specific organic solvent, the water-insoluble resin, and the surfactant having the structure represented by Formula (1) are mixed at room temperature or, if necessary, under heating. Then, it is preferable to filter the obtained mixed liquid with a predetermined filter. At this time, a dispersion containing the pigment and the pigment dispersant may be prepared in advance, and the remaining components may be added and mixed therein.

### (3) Printed Matter

The printed matter of the present invention is characterized by having a printing layer formed by using the aqueous inkjet ink on a non-absorbent film substrate.

The printed matter of the present invention is one in which an aqueous inkjet ink is ejected from an inkjet head to be applied and fixed on a substrate to form a printing layer. In addition, it is preferable that a pretreatment liquid for inkjet recording is previously ejected from an inkjet head on a substrate to form a pretreatment layer, and the printing layer is formed at a position where the pretreatment layer is applied and fixed.

Further, another functional layer may be formed between the substrate and the pretreatment layer, and a non-absorbent film substrate may be attached to the upper layer of the printing layer via a laminate adhesive layer, for example.

The “inkjet recording pretreatment liquid” in the present invention is one type of ink to be applied to a substrate in advance, which has a function of accelerating image formation of ink or improving image quality when an image is recorded on the substrate by an inkjet printing method. Specifically, the inkjet recording pretreatment liquid is an ink for fixing the ink at a position where the pretreatment liquid is applied to the recording medium so that the color ink which forms the image does not bleed into the recording medium. Such a pretreatment liquid for inkjet recording preferably contains at least resin particles, a coagulant and water.

### (3.1) Substrate

The substrate is not particularly limited, and may be a paper substrate having high water absorption, a substrate having low water absorption such as coated paper for gravure or offset printing, or a non-water absorbent substrate such as film, plastic board (soft vinyl chloride, hard vinyl chloride, acrylic plate, polyolefin system, etc.), glass, tile, and rubber.

Among them, the substrate having low water absorption and the substrate having no water absorption are particularly preferably a film (referred to as a non-absorbent film substrate in the present invention). By applying the inkjet recording pretreatment liquid of the present invention to such a substrate, the aqueous ink may be sufficiently pinned to form a high-quality image with little bleeding.

Examples of the above-mentioned film include known plastic films. Specific examples of the plastic film described above are a polyester film such as polyethylene terephthalate (PET), a polyethylene (PE) film including a high density polyethylene film and a low density polyethylene film, a polypropylene (PP) film, a polyamide films such as nylon (NY), a polystyrene film, an ethylene-vinyl acetate copolymer (EVA) film, a polyvinyl chloride (PVC) film, a polyvinyl alcohol (PVA) film, a polyacrylic acid (PAA) film, a polycarbonate film, a polyacrylonitrile film, and a biodegradable film such as a polylactic acid film. Moreover, in order to provide a gas barrier property, a moisture proof property, and an odor retention property, the film may be coated with polyvinylidene chloride on a single surface or on both surfaces of the film, and the film may be vapor-deposited with metal oxide. In addition, the film may be subjected to antifogging treatment. In addition, the film may be subjected to corona discharge treatment and ozone treatment.

The film may be either an un-stretched film or a stretched film.

The film may also be a multi-layered substrate in which a layer such as PVA coat is provided on the surface of an absorbent substrate such as paper to make the area to be recorded non-absorbent.

In addition, the effect of the present invention becomes remarkable when recording is performed on a non-water-absorbent film which has been subjected to anti-fogging treatment, in which it is generally difficult to obtain the adhesiveness of the recording ink.

Generally, a film containing a surfactant is used as the film subjected to the anti-fogging treatment, and it is known that this surfactant adversely affects the adhesiveness of the recording ink. It is presumed that when the pretreatment liquid of the present invention is precoated on such a film, the surfactant is dissolved and diffused in the pretreatment liquid to suppress the surfactant from being oriented at a high concentration at the interface with the recording ink layer, and as a result, the adhesiveness is not hindered.

The effect of the present invention that transparency is hardly impaired when recording is performed on a recording medium having high transparency is remarkable.

The thickness of the film is preferably less than 250 μm.

### (4) Inkjet Recording Method

The inkjet recording method of the present invention is characterized in that an image is recorded on a non-absorbent film substrate using the aqueous inkjet ink.

In the inkjet recording method of the present invention, it is preferable that the surface of the non-absorbent film substrate is precoated with an inkjet recording pretreatment liquid in advance, and then an image is recorded with an inkjet ink.

The method of precoating the pretreatment liquid is not particularly limited, but in order to obtain good adhesion of the recording inks, it is preferable that the amount of the composite resin particles contained in the pretreatment liquid is 0.3 g/m² or more, more preferably 0.8 g/m² or more, with respect to the recording medium. Although the application method of the pretreatment liquid on a film substrate is not particularly limited, for example, a wet application method such as a roller application method, a curtain application method, a spray application method, and an inkjet printing method may be preferably mentioned.

The inkjet head that is used in the inkjet printing method suitable for the present invention may be an on-demand system or a continuous system. Further, as a discharge method, any discharge method such as an electro-mechanical conversion method (for example, single cavity type, double cavity type, bender type, piston type, shear mode type, and shared wall type), or an electro-thermal conversion method (for example, thermal inkjet, and a bubble jet (registered trademark)) may be used.

In particular, an inkjet head (also referred to as a piezo inkjet head) using a piezoelectric element as the electro-mechanical conversion element used in the electro-mechanical conversion system is preferable.

In view of the fact that many common films are distributed in the form of rolls, it is preferable to use a single-pass inkjet recording method. The effect of the present invention is particularly remarkable in the single-pass inkjet recording method. That is, when using the single-pass inkjet recording method, high-definition images may be formed.

In the single-pass inkjet recording method, when the recording medium passes under one inkjet head unit, ink droplets are applied to all the pixels on which dots are to be formed in one pass.

It is preferable to use a line head type inkjet head as a means for achieving the single-pass type inkjet recording method.

The line head type inkjet head refers to an inkjet head having a length equal to or greater than the width of the printing area. As the line head type inkjet head, one head may be used that is equal to or more than the width of the printing range, or a plurality of heads may be combined to be equal to or more than the width of the printing range.

Further, it is also preferable to arrange a plurality of heads side by side so that the nozzles of each other are arranged in a staggered arrangement to increase the resolution of the heads as a whole.

The conveying speed of the recording medium may be set, for example, in the range of 1 to 120 m/min. The faster the conveying speed, the faster the image forming speed. According to the present invention, the occurrence of bleeding is further suppressed even at a very high linear velocity in the range of 50 to 120 m/min, which is applicable in the single-pass inkjet image forming method, and an image having high adhesion may be obtained.

After the application of the pretreatment liquid or the inkjet ink, the substrate may be dried. Drying may be performed by a known method such as infrared lamp drying, hot air drying, back heat drying, or reduced pressure drying. From the viewpoint of further improving the drying efficiency, it is preferable to dry the printed matter by combining two or more of these drying methods.

Hereinafter, a preferable example of the inkjet recording method and the recording apparatus of the present invention will be described.

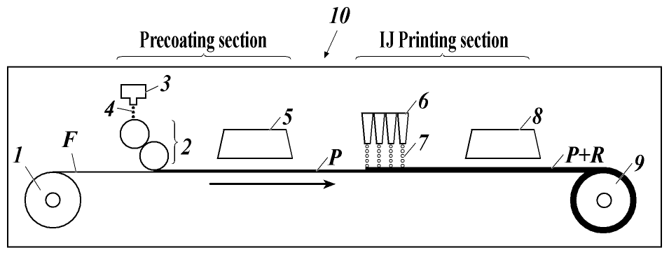

FIG. 1 is a schematic diagram of an inkjet recording apparatus 10 preferable in the present invention. However, the present invention is not limited to this, and for example, the first drying unit may be omitted.

A non-absorbent substrate F unwound from a feed roller is coated with pretreatment liquid droplets 4 discharged from a nozzle 3 by a roll coater 2 to form a pretreatment layer P. At this time, the pretreatment layer P is dried by the first drying unit. Next, an ink droplet 7 ejected from the inkjet head 6 is printed on the pretreatment layer P, an ink printing layer R is formed, and is wound by a winding roller 9 after drying by a second drying unit 8.

### EXAMPLES

Hereinafter, the present invention will be described in detail with reference to examples, but the present invention is not limited thereto. In the examples, “parts” or “%” is used, but unless otherwise specified, it indicates “parts by mass” or “mass %”.

### [Materials for Ink]

### <Resin>

Resins described in the following Table I were used.

TABLE I

| Resin | | Product | |
|---|---|---|---|
| No. | Kind | name | Manufacturer |
| R-1 | Urethane | WBR-016U | made by Taisei Fine |
| | resin | | Chemical Co., Ltd. |
| R-2 | Urethane-acrylic | WEM-202U | made by Taisei Fine |
| | resin | | Chemical Co., Ltd. |
| R-3 | Polyester | Elitel | made by Unitika Ltd. |
| | resin | KT-9204 | |
| R-4 | Polyolefin | Arrowbase | made by Unitika Ltd. |
| | resin | SB-1200 | |
| R-5 | Acrylic | SE-841A | made by Taisei Fine |
| | resin | | Chemical Co., Ltd. |

### <Organic Solvent>

Organic solvents described in the following Table II were used.

TABLE II

| Organic | | |
|---|---|---|
| solvent No. | Kind | Name |
| A-1 | Diol | Triethylene glycol |
| A-2 | Diol | Tripropylene glycol |
| A-3 | Diol | 1,2-Hexanediol |
| A-4 | Diol | 1,2-Butanediol |
| A-5 | Mono-alcohol | 1-Methoxy-1-propanol |
| A-6 | Mono-alcohol | 3-Methoxy-1-butanol |
| A-7 | Diol | 1,2-Ethanediol (ethylene glycol) |
| A-8 | Diol | 3-Oxapentane-1,5-diol (diethylene glycol) |
| A-9 | Diol | 1,2-Propanediol (propylene glycol) |
| A-10 | Diol | 1,3-Propanediol |
| A-11 | Diol | 2-Methy-1,3-propanediol |
| A-12 | Diol | 2,2-Dimethyl-1,3-propanediol |
| A-13 | Diol | 1,4-Butanediol |
| A-14 | Diol | 2-Methyl-2,4-pentanediol |
| A-15 | Diol | 3-Methyl-1,5-pentanediol |
| A-16 | Diol | 1,6-Hexanediol |
| A-17 | Glycol ether | Diethylene glycol diethyl ether |
| A-18 | Ester | Ethylene glycol monomethyl ether acetate |

### <Silicone Surfactant>

As silicone surfactants, surfactants S-1 to S-8 synthesized in Synthetic Examples below, and commercially available surfactants S-9 to S-11 were used.

### Synthetic Example of Surfactant S-1

A five-necked flask equipped with a stiffer, a refluxing condenser tube, a dropping funnel, a thermometer, and a nitrogen-introducing tube was charged with 450 parts by mass of allylated polyether (UNIOX PKA-5008 manufactured by Nippon Oil Co., Ltd.) and 0.01 parts by mass of hexachloroplatinic (IV) acid hexahydrate H₂PtCl₆.6H₂O (manufactured by Tokyo Chemical Industries, Ltd.) and nitrogen substitution was conducted. The mixture was heated to 70° C., then 220 parts by mass of heptamethyltrisiloxane (manufactured by Aldrich Co., Ltd.) was dropped over 1 hour, and the reaction vessel was allowed to warm to 110° C. for 4 hours. After the reaction, the unreacted material was distilled off under reduced pressure to obtain a silicone surfactant S-1, which was the target silicone surfactant. The obtained silicone surfactant S-1 is a silicone surfactant corresponding to R=a methyl group, X=an alkylene group having 3 carbon atoms, m=9, n=0 in Formula (1).

### Synthetic Example of Surfactant S-2

A silicone surfactant S-2 was obtained in the same manner as in the synthetic example of the surfactant S-1 except that 1,600 parts by mass of an allylated polyether (UNISAFE PKA-5015 manufactured by Nippon Oil Co., Ltd.) was used instead of 450 parts by mass of an allylated polyether (UNIOX PKA-5008 manufactured by Nippon Oil Co., Ltd.). The obtained silicone surfactant S-2 is a silicone surfactant corresponding to R=a butyl group, X=an alkylene group having 3 carbon atoms, m=25, n=6 in Formula (1).

### Synthetic Example of Surfactant S-3

A silicone surfactant S-3 was obtained in the same manner as in the synthetic example of the surfactant S-1 except that 200 parts by mass of an allylated polyether (UNIOX PKA-5001 manufactured by Nippon Oil Co., Ltd.) was used instead of 450 parts by mass of an allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=3, n=0 in Formula (1).

### Synthetic Example of Surfactant S-4

A silicone surfactant S-4 was obtained in the same manner as in the synthetic example of the surfactant S-1 except that 1,500 parts by mass of an allylated polyether (UNIOX PKA-5005 manufactured by Nippon Oil Co., Ltd.) was used instead of 450 parts by mass of an allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=33, n=0 in Formula (1).

### Synthetic Example of Surfactant S-5

A silicone surfactant S-5 was obtained in the same manner as in the synthetic example of the surfactant S-1 except that 2,000 parts by mass of an allylated polyether (UNIOX PKA-5013 manufactured by Nippon Oil Co., Ltd.) was used instead of 450 parts by mass of an allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=22, n=16 in Formula (1).

### Synthetic Example of Surfactant S-6

A silicone surfactant S-6 was obtained in the same manner as in the synthesis example of the surfactant S-1 except that 450 parts by mass of an allylated polyether (UNIOX PKA-5003 manufactured by Nippon Oil Co., Ltd.) was used instead of 450 parts by mass of an allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=9, n=0 in Formula (1).

### Synthetic Example of Surfactant S-7

A silicone surfactant S-7 was obtained in the same manner as in the synthesis example of the surfactant S-1 except that 750 parts by mass of an allylated polyether (UNISEFE PKA-5011 manufactured by Nippon Oil Co., Ltd.) was used instead of 450 parts by mass of an allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=12, n=3 in Formula (1).

### Synthetic Example of Surfactant S-8

A silicone surfactant S-8 was obtained in the same manner as in the synthesis example of the surfactant S-1 except that 105 parts by mass of ethylene glycol monoallyl ether (manufactured by Tokyo Chemical Industry Co., Ltd.) was used instead of 450 parts by mass of allylated polyether (UNIOX PKA-5008 manufactured by Nippon Oil Co., Ltd.). The obtained silicone surfactant is a silicone surfactant corresponding to R=a hydrogen atom, X=an alkylene group having 3 carbon atoms, m=1, n=0 in Formula (1).

The following commercial products were used as the silicone surfactants S-9 to S-11.

S-9: BYK-333 (manufactured by BYK-Chemie)

S-10: BYK-347 (manufactured by BYK-Chemie)

S-11: BYK-348 (manufactured by BYK-Chemie)

### <Preparation of Aqueous Inkjet Ink 1>

A pigment dispersion liquid was prepared by pre-mixing a mixture of 18 mass % of pigment (Pigment Blue 15:3), 31.5 mass % of a pigment dispersant (JONCRYL 819 manufactured by BASF Corporation, an acid value of 75 mg KOH/g, a solid content of 20 mass %), 20 mass % of ethylene glycol, and ion-exchanged water (remaining amount: a total amount of 100% by mass). Then the mixture was dispersed using a sand grinder filled with 50 volume % of 0.5 mm zirconia beads to obtain a pigment dispersion liquid having a pigment content of 18 mass % The average particle diameter of the pigment particles contained in the pigment dispersion 2 was 109 nm. The average particle diameter of the particles was measured by “Zetasizer 1000Hs” made by Malvern Panalytical Ltd.

17.0 parts by mass of the pigment dispersion liquid, 5.0 parts by mass of resin (R-1), 5.0 parts by mass of organic solvent (A-1), 0.05 parts by mass of a surfactant (S-1) and ion-exchanged water (remaining amount; 72.95 parts by mass) were added while stirring. The resulting mixture was filtered through a 1 μm filter to obtain an aqueous inkjet ink 1. There was no substantial change in composition before and after filtration.

### <Preparation of Aqueous Inkjet Inks 2 to 29>

Aqueous inkjet inks 2 to 29 were prepared in the same manner as used for preparation of the aqueous inkjet ink 1 except that the types of the resin, the organic solvent and the surfactant and the mass parts of the respective ink components (resin, organic solvent, pigment dispersion liquid, surfactant and water) were changed as indicated in the following Table III.

### [Evaluation]

### <Inkjet Recording Method>

Two independently driven piezo type inkjet heads (made by Konica Minolta, Inc., 360 dpi, discharge amount 14 pL) were arranged so that the nozzles were staggered, and a head module of 720 dpi×720 dpi was created, and they were installed on the stage carrier so that the nozzle rows were orthogonal to the carrier direction. An inkjet recording apparatus was configured so that the head module was filled with the inkjet ink and a solid image was recorded by a single-pass method on a layer formed on a surface of a substrate conveyed by a stage conveyor. An OPP film FOS (Futamura Chemical Co., Ltd.) was used as a substrate. Using the above head, the droplets of the aqueous inkjet ink 1 were ejected so that a solid image of 720 dpi×720 dpi with an ink coverage of 11.2 mL/m² was formed.

### (Image Quality)

With the solid image created above, the image quality of the entire image was visually evaluated.

AA: A good image with excellent ink wettability, uniform image density without unevenness, and no ink dropout.

BB: A practically acceptable image with good ink wettability, having a portion of non-uniform density but no ink dropout.

CC: An image in which the ink wettability is slightly insufficient and there is a portion where the ink has dropout, and there is a slight amount of white spots.

DD: An image in which the ink wettability is insufficient, and there are many areas where the ink has dropout, and white spots are noticeable.

### (Adhesiveness)

The solid image created by the above-mentioned recording method was cut with a cutter in a 5×5 grid pattern at 1 mm intervals, and a tape peeling test by a cross cut method was performed. Evaluation was performed according to the following criteria.

AA: No peeling by tape and it is an excellent level.

BB: There is peeling of 1 to 3 squares of cuts in a grid pattern, but it is a good level.

CC: There is peeling of 4 to 6 squares of cuts in a grid pattern, but it is a practically acceptable level.

DD: There is peeling of 7 or more squares of cuts in a grid pattern, it is practically unacceptable level.

### (Storage Stability)

The inkjet ink prepared above was thermally stored at 60° C. for 1 week, and then the average particle diameter was measured using “Zetasizer 1000HS” manufactured by Malvern Panalytical Ltd. The particle size increase rate was calculated from the obtained average particle size and the average particle size before storage, and evaluation was made based on the following criteria.

AA: Increase rate of average particle size is less than 120%

BB: Increase rate of average particle size is 120% or more and less than 140%

CC: Increase rate of average particle size is 140% or more and less than 160%

DD: Increase rate of average particle size is 160% or more

### (Water Resistance)

The images produced above were stored at 40° C. for 3 days, and then cut into strips of 10 cm×1 cm so that the solid portion became a cut end surface to obtain test pieces. The test piece was treated with hot water for 30 minutes, and the state of the test piece after the process was visually confirmed, and the hot water resistance of the image by each ink was evaluated by the following criteria.

AA: No peeling of the test piece

BB: Partial peeling of the test piece occurred, but no significant peeling occurred.

CC: Large peeling of the test piece occurred.

DD: All image portions are peeled off from the test piece film.

TABLE III

| | | | Organic | | | | | | | | | | |
|---|---|---|---|---|---|---|---|---|---|---|---|---|---|
| | Resin | | solvent | | Surfactant | | Pigment | | | | | | |
| | | Content in | | Content in | | Content in | dispersion | | Evaluation | | | | |
| | | the Ink | | the Ink | | the Ink | liquid | Water | | | Adhesive- | Water | |
| Ink | | (parts | | (parts | | (parts | (parts | (parts | White | Storage | ness to | resis- | |
| No. | No. | by mass) | No. | by mass) | No. | by mass) | by mass) | by mass) | spots | stability | substrate | tance | Remarks |
| 1 | R-1 | 5.0 | A-1 | 5.0 | S-1 | 0.05 | 17.0 | 72.95 | CC | CC | BB | CC | Present invention |
| 2 | R-2 | 5.0 | A-2 | 55.0 | S-1 | 3.5 | 17.0 | 19.5 | BB | CC | BB | CC | Present invention |
| 3 | R-3 | 5.0 | A-3 | 5.0 | S-1 | 0.5 | 17.0 | 72.5 | BB | CC | BB | CC | Present invention |
| 4 | R-4 | 5.0 | A-4 | 55.0 | S-1 | 1.5 | 17.0 | 21.5 | BB | CC | BB | CC | Present invention |
| 5 | R-1 | 5.0 | A-5 | 5.0 | S-1 | 3.0 | 17.0 | 70.0 | BB | CC | BB | CC | Present invention |
| 6 | R-2 | 5.0 | A-6 | 55.0 | S-1 | 3.0 | 17.0 | 20.0 | BB | CC | BB | CC | Present invention |
| 7 | R-3 | 5.0 | A-7 | 5.0 | S-1 | 1.5 | 17.0 | 71.5 | BB | BB | BB | BB | Present invention |
| 8 | R-4 | 5.0 | A-8 | 55.0 | S-2 | 1.5 | 17.0 | 21.5 | BB | BB | BB | BB | Present invention |
| 9 | R-1 | 5.0 | A-9 | 5.0 | S-1 | 1.5 | 17.0 | 71.5 | BB | BB | BB | BB | Present invention |
| 10 | R-2 | 5.0 | A-10 | 55.0 | S-2 | 1.5 | 17.0 | 21.5 | BB | BB | BB | BB | Present invention |
| 11 | R-3 | 5.0 | A-7 | 10.0 | S-1 | 1.5 | 17.0 | 66.5 | BB | AA | BB | AA | Present invention |
| 12 | R-4 | 5.0 | A-8 | 20.0 | S-2 | 1.5 | 17.0 | 56.5 | BB | AA | BB | AA | Present invention |
| 13 | R-1 | 5.0 | A-9 | 30.0 | S-1 | 1.5 | 17.0 | 46.5 | BB | AA | BB | AA | Present invention |
| 14 | R-2 | 5.0 | A-10 | 40.0 | S-2 | 1.5 | 17.0 | 36.5 | BB | AA | BB | AA | Present invention |
| 15 | R-3 | 5.0 | A-11 | 25.0 | S-3 | 1.5 | 17.0 | 51.5 | AA | AA | BB | AA | Present invention |
| 16 | R-4 | 5.0 | A-12 | 25.0 | S-4 | 1.5 | 17.0 | 51.5 | AA | AA | BB | AA | Present invention |
| 17 | R-1 | 5.0 | A-13 | 25.0 | S-5 | 1.5 | 17.0 | 51.5 | AA | AA | BB | AA | Present invention |
| 18 | R-2 | 5.0 | A-14 | 25.0 | S-6 | 1.5 | 17.0 | 51.5 | AA | AA | AA | AA | Present invention |
| 19 | R-3 | 5.0 | A-15 | 25.0 | S-7 | 1.5 | 17.0 | 51.5 | AA | AA | AA | AA | Present invention |
| 20 | R-4 | 5.0 | A-16 | 25.0 | S-1 | 1.5 | 17.0 | 51.5 | AA | AA | AA | AA | Present invention |
| 21 | R-1 | 5.0 | A-1 | 25.0 | S-8 | 1.5 | 17.0 | 51.5 | DD | BB | CC | CC | Comparative |
| | | | | | | | | | | | | | example |
| 22 | R-2 | 5.0 | A-2 | 25.0 | S-9 | 1.5 | 17.0 | 51.5 | DD | BB | CC | CC | Comparative |
| | | | | | | | | | | | | | example |
| 23 | R-3 | 5.0 | A-3 | 25.0 | S-10 | 1.5 | 17.0 | 51.5 | DD | BB | CC | CC | Comparative |
| | | | | | | | | | | | | | example |
| 24 | R-4 | 5.0 | A-4 | 25.0 | S-11 | 1.5 | 17.0 | 51.5 | DD | BB | CC | CC | Comparative |
| | | | | | | | | | | | | | example |
| 25 | R-1 | 5.0 | A-17 | 25.0 | S-1 | 1.5 | 17.0 | 51.5 | BB | DD | BB | DD | Comparative |
| | | | | | | | | | | | | | example |
| 26 | R-2 | 5.0 | A-18 | 25.0 | S-2 | 1.5 | 17.0 | 51.5 | BB | DD | BB | DD | Comparative |
| | | | | | | | | | | | | | example |
| 27 | R-3 | 5.0 | A-6 | 25.0 | — | — | 17.0 | 53.0 | DD | BB | DD | CC | Comparative |
| | | | | | | | | | | | | | example |
| 28 | R-4 | 5.0 | — | — | S-4 | 1.5 | 17.0 | 76.5 | DD | BB | CC | DD | Comparative |
| | | | | | | | | | | | | | example |
| 29 | R-5 | 5.0 | A-7 | 25.0 | S-5 | 1.5 | 17.0 | 51.5 | CC | BB | DD | DD | Comparative |
| | | | | | | | | | | | | | example |

As shown in the above results, it is recognized that the ink of the present invention has higher image quality, better adhesion to the substrate, and excellent storage stability and water resistance compared with the inks of comparative examples.

### INDUSTRIAL APPLICABILITY

The aqueous inkjet ink of the present invention enables to provide an aqueous inkjet ink having excellent wettability to a substrate, excellent storage stability of the ink, and excellent water resistance. The aqueous inkjet ink of the present invention also enables to provide a printed matter, and an inkjet recording method.

### DESCRIPTION OF SYMBOLS

F: Substrate
P: Pretreatment layer
R: Printing layer
1: Feed roller
2: Roll coater
3: Nozzle
4: Pretreatment liquid droplets
5: First drying unit
6: Inkjet head
7: Ink droplets
8: Second drying unit
9: Winding roller
10: Inkjet recording apparatus

1. An aqueous inkjet ink comprising at least water, a pigment, an organic solvent, a resin, and a surfactant, wherein an alcohol is contained as the organic solvent; the resin is a water-insoluble resin containing at least one of a polyester skeleton, a polyolefin skeleton, and a polyurethane skeleton; and a silicone surfactant having a structure represented by the following Formula (1) is contained as the surfactant, 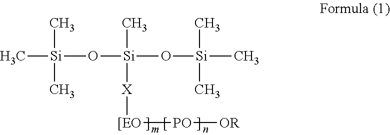
wherein R represents a hydrogen atom or a hydrocarbon group having 1 to 4 carbon atoms; X is an alkylene group having 2 to 6 carbon atoms and may have a branched structure; EO represents a repeating unit structure of an ethylene oxide group, PO represents a repeating unit structure of a propylene oxide group, and an order of [EO]ₘ and [PO]ₙ is arbitrary; m and n represent a number of the repeating unit structures, m is an integer of 2 to 50, and n is an integer of 0 to 20.

2. The aqueous inkjet ink described in claim 1, wherein a content of the silicone surfactant is in the range of 0.1 to 3.0 mass % with respect to a total mass of the ink.

3. The aqueous inkjet ink described in claim 1, wherein the alcohol having 1 to 3 hydroxy groups is contained as the organic solvent.

4. The aqueous inkjet ink described in claim 1, wherein the organic solvent is at least one selected from the group consisting of 1,2-ethanediol, 3-oxapentane-1,5-diol, 1,2-propanediol, 1,3-propanediol, 2-methyl-1,3-propanediol, 2,2-dimethyl-1,3-propanediol, 1,4-butanediol, 2-methyl-2,4-pentanediol, 3-methyl-1,5-pentanediol, and 1,6-hexanediol.

5. The aqueous inkjet ink described in claim 1, wherein a content of the organic solvent is in the range of 10 to 50 mass % with respect to a total mass of the ink.

6. A printed matter having a printing layer on a non-absorbent film substrate formed with the aqueous inkjet ink described in claim 1.

7. An inkjet recording method comprising the step of recording an image on a non-absorbent film substrate by using the aqueous inkjet ink described in claim 1.
